(19) United States
(12) Patent Application Publication
(10) Pub. No.: US 2022/0327798 A1
(43) Pub. Date: Oct. 13, 2022

(54) Detecting a Moving Stream of Objects

(71) Applicant: SICK AG, Waldkirch (DE)

(72) Inventors: Romain MÜLLER, Waldkirch (DE); Dirk STROHMEIER, Waldkirch (DE)

(21) Appl. No.: 17/717,343

(22) Filed: Apr. 11, 2022

(30) Foreign Application Priority Data
Apr. 12, 2021 (DE) 102021109078.4

(51) Int. Cl. G06V 10/25; H04N 5/77; H04N 5/232; H04N 5/247; G06T 7/20; G01B 11/24; G01P 3/00; G01S 17/86; G01S 7/4865; G01S 17/10; G06K 7/14

(52) U.S. Cl. CPC G06V 10/25; H04N 5/77; H04N 5/232125; H04N 5/247; G06T 7/20; G01B 11/24; G01P 3/00; G01S 17/86; G01S 7/4865; G01S 17/10; G06K 7/1413; G06T 2200/24; G06T 2207/10016

(57) ABSTRACT

A camera device for detecting a stream of objects moved relative to the camera device is provided that has an image sensor for recording image data of the objects, a geometry detection sensor for measuring the objects, and a control and evaluation unit that is configured to determine at least one region of interest using measured data of the geometry detection sensor to restrict the evaluation of the image data to the region of interest. In this respect, the image sensor has a configuration unit to enable the reading of only a settable portion of the respectively recorded image data; and the control and evaluation unit is configured only to read a portion of the image data from the image sensor that is determined with reference to the region of interest.

The invention relates to a camera device and to a method of detecting a moving stream of objects.

Cameras are used in a variety of ways in industrial applications to automatically detect object properties, for example for the inspection or for the measurement of objects. In this respect, images of the object are recorded and are evaluated in accordance with the task by image processing methods. A further use of cameras is the reading of codes. Objects with the codes located thereon are recorded using an image sensor and the code regions are identified in the images and then decoded. Camera-based code readers also cope without problem with different code types than one-dimensional barcodes which also have a two-dimensional structure like a matrix code and provide more information. The automatic detection of the text of printed addresses, (optical character recognition, OCR) or of handwriting is also a reading of codes in principle. Typical areas of use of code readers are supermarket cash registers, automatic parcel identification, sorting of mail shipments, baggage handling at airports, and other logistic applications.

A frequent detection situation is the installation of the camera above a conveyor belt. The camera records images during the relative movement of the object stream on the conveyor belt and instigates further processing steps in dependence on the object properties acquired. Such processing steps comprise, for example, the further processing adapted to the specific object at a machine which acts on the conveyed objects or a change to the object stream in that specific objects are expelled from the object stream within the framework of a quality control or the object stream is sorted into a plurality of partial object streams. If the camera is a camera-based code reader, the objects are identified with reference to the affixed codes for a correct sorting or for similar processing steps.

More powerful image sensors are increasingly becoming available so that a large zone, for example of the width of a conveyor belt, can be covered with a few cameras. However, with different object heights, situations arise again and again in which the depth of field zone is not sufficient to record all the objects in the field of view with sufficient focus. In principle, a focus adjustment provides a way out here. However, a fast sequence of recordings is required for this purpose since otherwise the object to be recorded is no longer detected or is at least no longer recorded in the correct perspective. The required high recording frequency cannot be achieved with a large image sensor since more data are produced than can be processed between two recordings. Smaller image sensors would be of help in this situation, but the desired advantage of covering a large zone with few or, in the ideal case, with only a single camera would thereby be abandoned.

The depth of field zone can in principle be expanded with a small diaphragm and additional illumination to compensate the light loss and thus a worse signal-to-noise ratio. The anyway powerful illumination would, however, thereby become even more costly. It additionally does not reduce the data load. The use of an image sensor having an overwide aspect ratio by which the conveyor belt could be covered without increasing the data quantity by too much would furthermore be conceivable. Such exotic image sensors are, however, not available or would at least considerably restrict the choice with respect to other factors decisive for the image sensors. In addition, a large field of vision also absolutely has advantages in the conveying direction that are lost with overwide image sensors.

EP 1 645 838 B1 and EP 1 646 839 B1 each disclose a device for monitoring moving objects on a conveyor belt. A distance measurement device or laser scanner is disposed upstream of a camera and regions of interest (ROIs) are determined with its data to which the later evaluation of the image data is restricted. A line scan camera is used here whose image lines are assembled to an image. All the image data are consequently first incurred and are only reduced later. A matrix camera is mentioned only mentioned as an addition, without explaining how its image data should be dealt with. A matrix camera in this form only intensifies the problem of the data quantities with respect to a line scan camera since the image lines are even redundantly detected in many cases.

In DE 20 2006 020 599 U1, measured geometric data are used in advance to determine regions of interest and then to detect them with a higher resolution than regions of no interest. The difference comprises in an embodiment that image data in the regions of interest are evaluated more completely than in the regions of no interest, which then only produces a further variant of EP 1 645 838 B1 and EP 1 645 839 B1. Alternatively, only every third or tenth line is, for example, evaluated in the regions of no interest. Fewer data are thus only incurred in those times in which the total field of view of the line scan camera is uniformly a region of no interest. In addition, the procedure would not be transferrable to a matrix camera at al.

EP 2 693 363 A1 describes a camera system that utilizes geometric data detected in advance to focus a plurality of cameras in a complementary manner. This is based on the redundant detection of the objects in a plurality of cameras and is therefore unsuitable for a system in which, where possible, only one camera covers the total width of the object streams to be detected. In addition, the total data quantity is even again multiplied by the redundancy.

A camera is known from EP 3 537 339 A1 in which an optoelectronic distance sensor in accordance with the principle of the time of flight process is integrated. Its data are used for a plurality of functions which also include the fixing of regions of interest using a height profile acquired from the distance values. The regions of interest are, however, treated as additional information or the image is cropped to a region of interest in a possible processing step. The data to be processed are thus either not reduced at all or only in a later processing step.

U.S. Pat. No. 9,237,286 B2 presents an image sensor that allows an energy efficient reading of sub-images. In this respect, the term of regions of interest (ROIs) is mentioned in the introduction, but the document does not deal with the use, but rather with the explanation of the image sensor on the hardware level.

It is therefore the object of the invention to further improve the detection of a moving stream of objects

This object is satisfied by a camera device and by a method for detecting a moving stream of objects in accordance with the respective independent claim. The camera device records image data of the objects moved relative to an image sensor using said image sensor. The image sensor preferably covers a large portion or the total width, viewed from a plane view, or with a lateral perspective of the height of the stream and a certain length in the direction of movement and accordingly has a plurality of light reception elements or pixels in a matrix arrangement of a resolution of typically several megapixels. A geometry detection sensor measures the object geometry. A distance sensor that measures the respective distance from the objects is in particular suitable for this purpose. With knowledge of the position and pose of the geometry detection sensor, a height contour in the direction of movement and preferably also transversely thereto can be generated from this in the course of the relative movement.

A control and evaluation unit uses the measured data of the geometry detection sensor to determine at least one region of interest, for example having an object, an object surface, or any other structure relevant to the camera device. The further evaluation of the image data is then limited to the regions of interest (“cropping”). If the measured data include intensity or color information, information that is not purely geometrical such as brightness levels, colors, or contrasts can alternatively or additionally be used for the determination of the regions of interest. To determine regions of interest in the plane of the image sensor with reference to geometry data, the image sensor and the geometry detection sensor are preferably calibrated to one another and a corresponding transformation takes place.

The invention starts from the basic idea of restricting the image data directly at the source in the image sensor to the at least one region of interest. The image sensor has a configuration unit and so provides a configuration option to only have a settable portion or portion range of the image data read. The control and evaluation unit uses this configuration option to adapt the portion of the image data to be read to the at least one region of interest. Exactly those pixels or pixel lines that form a region of interest are in particular read. However, this preferably only coincides in a pixel-perfect manner. Buffer zones or cropped partial regions of a region of interest are conceivable, as are restricted configuration options that only allows access to certain pixel groups together or restricts such access. Image data without reference to a region of interest do not have to be read at all.

The invention has the advantage that the image data are reduced to the essential from the start. This has great advantages at a number of points of the image processing chain. Bandwidths for data transmission, memory and processing resources, and processing time are saved. No quality loss is associated with this since the regions of no interest do not anyway include any information relevant to the use. The initially described disadvantages of a few cameras or of only a single camera that cover(s) the total width or height of the stream of objects are thus overcome. In combination with a focus adjustment, it can be ensured that all the regions of interest are imaged in focus in at least one recording.

The control and evaluation unit is preferably configured to adapt the at least one region of interest and/or the read portion of the image data between the recordings. The objects having the structures of interest are located in a relative movement with respect to the camera device so that the location of the regions of interest in the plane of the image sensor varies constantly. In addition, objects leave the field of vision and new objects come in. This is taken into account by the adaptation. The image sensor or its configuration unit therefore preferably provides the option of a dynamic reconfiguration, preferably with a brief response time below the recording period. The adaptation can, but does not necessarily have to take place after every single recording. In addition, the control and evaluation unit can draw the conclusion on the adaptation that the previous configuration is still appropriate, in particular in that regions of interest are determined and read with a certain buffer that is sufficient for a short period of time between two or some recordings.

The control and evaluation unit preferably has a pre-processing unit to read and pre-process image data from the image sensor, with the pre-processing unit being configured such that the reading and pre-processing of the complete image data of a recording of the image sensor would require a complete pre-processing time and with the image sensor being operated at a recording frequency that leaves less time between two recordings than the complete pre-processing time, in particular of a flexible recording frequency. The pre-processing unit preferably comprises at least one FPGA (field programmable array), at least one SDP (digital signal processor), at least one ASIC (application-specific integrated circuit), at least one VPU (video processing unit), or at least one neural processor and performs pre-processing steps such as equalization, brightness adaptation, binarization, segmentation, location of code regions, and the like. The pre-processing unit would require a complete processing time for the reading and pre-processing of a complete image of the image sensor; 25 ms is a numerical example of this purely for understanding. This is expressed in the subjunctive because the complete image data are not read in accordance with the invention. It nevertheless describes the hardware resources of the pre-processing unit such as the bandwidth of the data transmission, the processing capacity, or the memory capacity.

The recording period of the image sensor is preferably set as shorter than the complete pre-processing time. In other words, the recording frequency is so high that the pre-processing unit could no longer deal with the complete image data. In the example of a complete pre-processing time of 25 ms, the highest still managed recording frequency would be 40 Hz, but the image sensor is operated at a higher frequency of, for example, 50-100 Hz or more. Further pre-processing steps such as a code reading that take up even more time even in the case of a pipeline structure can follow the pre-processing. This further increases the advantage of the specific reading of only image data that are linked with regions of interest. The recording frequency can be flexible. As soon as the configured portions of the image data have been read, the next image can be recorded and the time required for this depends on the size of the currently determined regions of interest. A flexible recording frequency here remains higher than that recording frequency that would correspond to the complete pre-processing time.

The configuration unit is preferably configured for a selection of image lines. The read image data are thereby no longer a fully perfect fit for regions of interest that only utilize a portion of the width of the lines. The hardware of the image sensor and its control for reading is simplified for this purpose. The processing time in the total image processing chain from the reading onward reduces linearly with the non-selected image lines. It is here assumed, without any restriction of generality, that the line direction of the image sensor is arranged transversely to the conveying direction. An alternative in which the columns take over the role of lines and vice versa would equally be conceivable; this should no longer be separately distinguished linguistically.

The configuration unit is preferably configured for the selection of a rectangular partial region. Not only whole lines can thus be excluded, but a cropping to the regions of interest Is also already directly possible in the line direction at the source in the image sensor. The hardware structure and the control of the image sensor becomes a little more complex and/or expensive, but the image data read and to be processed are in turn reduced in an even better fit.

The control and evaluation unit is preferably configured only to read that portion of the image data from the image sensor that was recorded with reference to a region of interest within a depth of field zone of the image sensor. There are only good prospects that the further image processing chain will satisfy its functions with image data recorded in focus. There can be at least one further region of interest that is outside the depth of field zone and whose image data are not read at all. Only time would probably be lost here due to further processing steps, in particular the attempt of decoding codes, without reaching the desired result. A focus adjustment preferably provides a region of interest being in the depth of field zone. However, this alone does not yet solve the problem since there can be a plurality of objects in the field of vision whose height difference forces parts of the field of vision outside every depth of field zone. A region of interest recorded as blurred then results despite the focus adjustment.

The control and evaluation unit is preferably configured to determine a suitable depth of field zone for a region of interest outside the depth of field zone and to refocus to the suitable depth of field zone for a following recording. If therefore the image data of a region of interest have to be ignored or not even read in the first place because they were blurred, there is the possibility of fast compensation. For this purpose, a previously ignored region of interest is now recorded again in the depth of field zone and then also read with one of the following recordings, preferably the directly following recording, after a refocus. Even if two different depth of field zones are still not sufficient to record all the regions of interest in focus, the process can be iterated. A much higher recording frequency is possible thanks to the reduced image data through a targeted reading of only regions of interest, in particular even only regions of interest recorded in focus. The further recording therefore takes place in good time with a practically unchanged scenery, at least before the object has left the field of vision. Due to the measured data of the geometry detection sensor, the sequence of the focal positions can in another respect be planned in good tie to record every region of interest in focus sufficiently frequently. If, for example, there is still sufficient time, as in the case of two objects of different height that do not very closely follow one another, at least one further recording in the current focal position would still be conceivable before then the focal position is changed for the other object and a region of interest related thereto.

The control and evaluation unit is preferably configured to determine the at least one region of interest using a depth of field zone of the image sensor. This is in a certain manner a reversal of the last explained procedure. A choice is not made between regions of interest found according to other criteria with reference to the focal position, but the focal position itself defines the regions of interest in a very simple manner. Everything that was able to be recorded sufficiently in focus is read so that image data that can be evaluated are by no means discarded prematurely. A possible more specific determination of regions of interest in accordance with more complex criteria such as edges, contrasts, or object surfaces then only takes place downstream. If the depth of field zone is preferably still varied, as with an oscillating focal position, it is always ensured that every structure in short cycles was recorded in focus and read at least once.

The control and evaluation unit is preferably configured to identify code regions in the image data and to read their code content. The camera device thus becomes a camera-based code reader for barcodes and/or 2D codes according to various standards, optionally also for text recognition (optical character recognition, OCR). It is particularly important in code reading applications that all the code regions are recorded in sufficient focus. At the same time, the code regions only take up a small portion of the total surface. An early cropping of the image data to code regions or at least the potentially code bearing objects is therefore particularly effective.

The geometry detection sensor is preferably configured as a distance sensor, in particular as an optoelectronic distance sensor in particular in accordance with the principle of the time of flight process. The distance sensor initially measures the distance of the objects from the geometry sensor, which, however, can be converted with knowledge of the position and pose of the distance sensor into a height of the object, for example above a conveying belt. A height contour thus results at least in the direction of movement. If the distance sensor is spatially resolving, a height contour transverse to the direction of movement is also detected. The term height contour is based on a plan view of the image sensor; a corresponding contour is accordingly detected from a different perspective. An optical principle, in particular a time of flight process, is suitable for distance measurement in a camera system.

The geometry detection sensor is preferably integrated with the image sensor in a camera. This produces a particularly compact system and the measured data of the geometry detection sensor from a perspective comparable with the image data. Alternatively, the geometry detection sensor is arranged externally and upstream of the image sensor against the flow to measure the objects prior to the recording of the image data. It is, for example, a distance measuring laser scanner.

The camera device preferably has a speed sensor for a determination of the speed of the stream. It is, for example, an encoder at a conveyor belt. The control and evaluation unit is preferably configured to determine the speed of the stream using the measured data of the geometry detection sensor and/or the image data. A specific structure such as an object edge is tracked over time for this purpose, for example. The displacement factor can be in relation to the time difference to estimate the speed. The optical flow can be determined more exactly by additional correlations up to the total height contour or whole image regions. An additional speed sensor is then not necessary or is supplemented. Positions in the direction of movement of the stream can be converted using the speed information; measured data of an upstream geometry detection sensor can in particular be related to the position of the image sensor.

The camera device is preferably installed as stationary at a conveying device which conveys the objects in a conveying direction. This is a very frequent industrial application of a camera. Outline data of the stream of objects are known and simplify the image processing such as the conveying direction and also the speed, at least in an interval that can be anticipated, and often also the kind and rough geometry of the objects to be detected.

The camera device preferably has at least one image sensor for a recording of the stream from above and/or at least one image sensor for a recording of the stream from the side. The detection from above is often the directing conception in this description, but there is also a comparable situation with a detection from the side, where the object distance now does not vary due to the object height, but rather due to the lateral position. Descriptions that refer to the perspective from above can therefore accordingly be read for a different perspective in all cases. Objects are particularly preferably detected by a plurality of image sensors from a plurality of perspectives, in particular during code reading, where it cannot always be ensured that the code is located on the upper side or at a certain side at all. The terms top reading, side reading, and bottom readings are sometimes used here. The latter, however, does not cause any problems with respect to the depth of field zone. Instead, for example, a window or a gap in the conveyor belt has to be made to be able to perceive the objects at all. The perspectives are in another respective frequently mixed forms, i.e. not a direct plan view or side view, but rather with an oblique component such as laterally frontal, laterally rear, top front, or top rear. Only one image sensor that correspondingly covers the height or width of the object stream is preferably provided per perspective.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

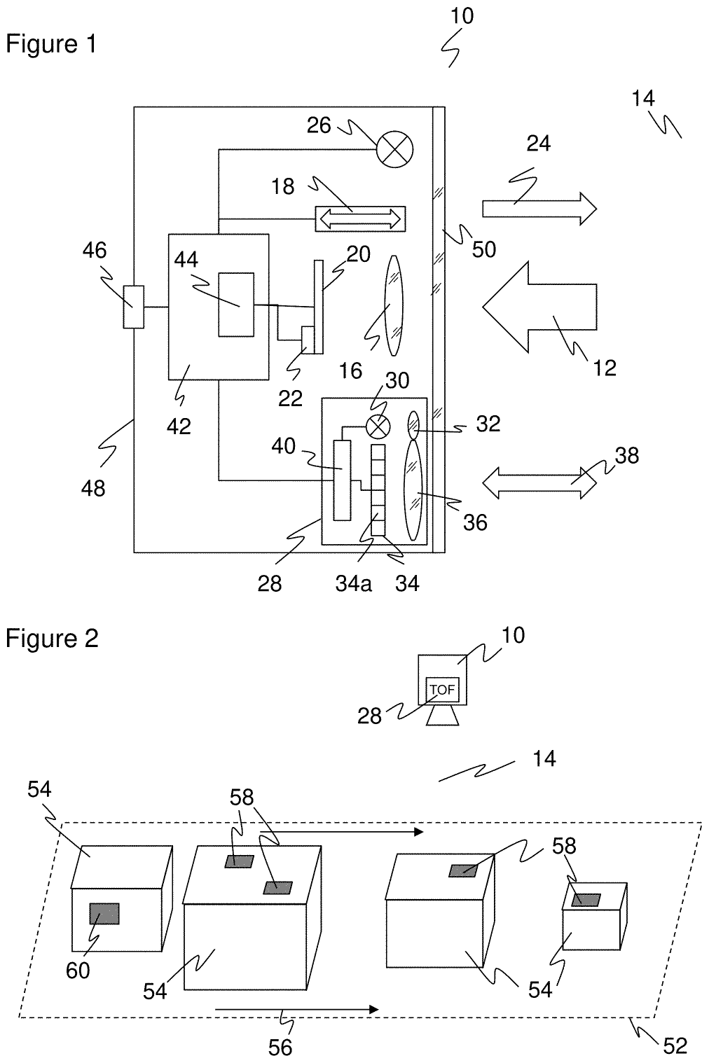

FIG. 1 a schematic sectional representation of a camera with an integrated distance sensor;

FIG. 2 a three-dimensional view of an exemplary use of the camera in an installation at a conveyor belt;

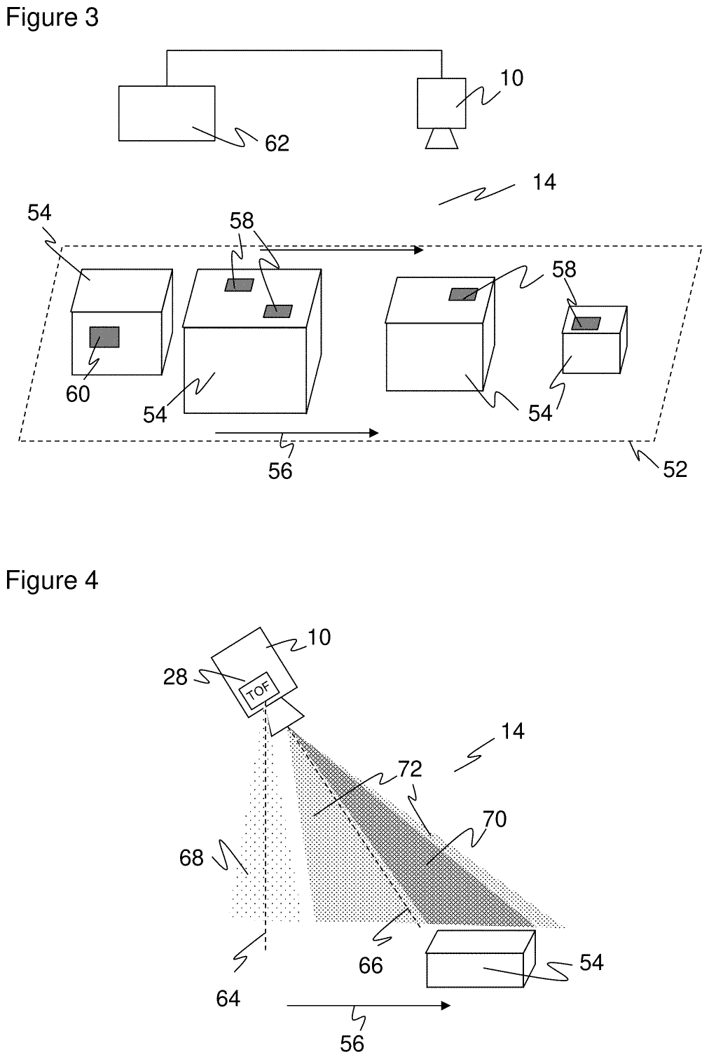

FIG. 3 a three-dimensional view of an alternative embodiment with an installation of a camera and an external distance sensor at a conveyor belt;

FIG. 4 a schematic sectional representation of fields of vision of the distance sensor and of the camera;

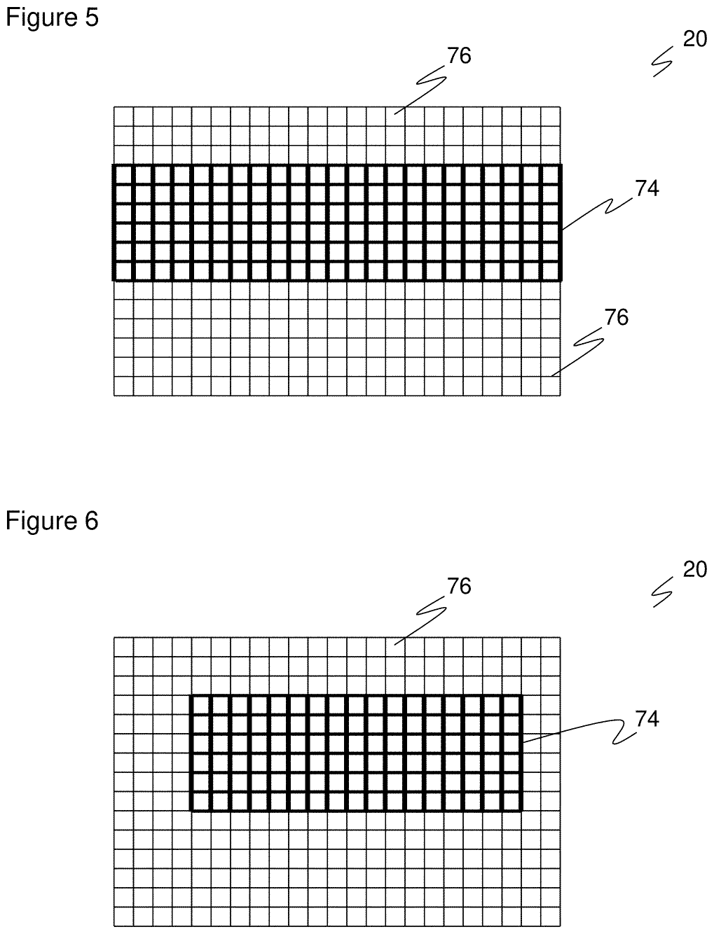

FIG. 5 a schematic representation of an image sensor with image lines corresponding to a region of interest configured for reading;

FIG. 6 a schematic representation similar to FIG. 5 with an additional configuration of pixels to be read also within image lines;

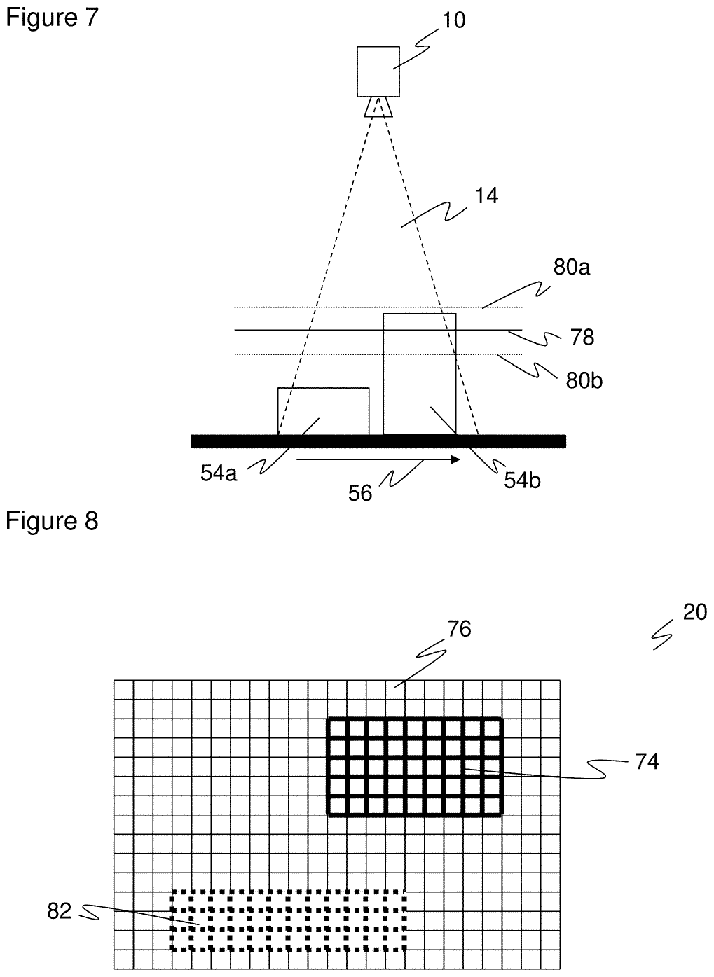

FIG. 7 a schematic sectional representation of the detection of two objects with a limited depth of field zone;

FIG. 8 a schematic representation of an image sensor with a partial region corresponding to a region of interest configured for reading in the depth of field zone in accordance with FIG. 7;

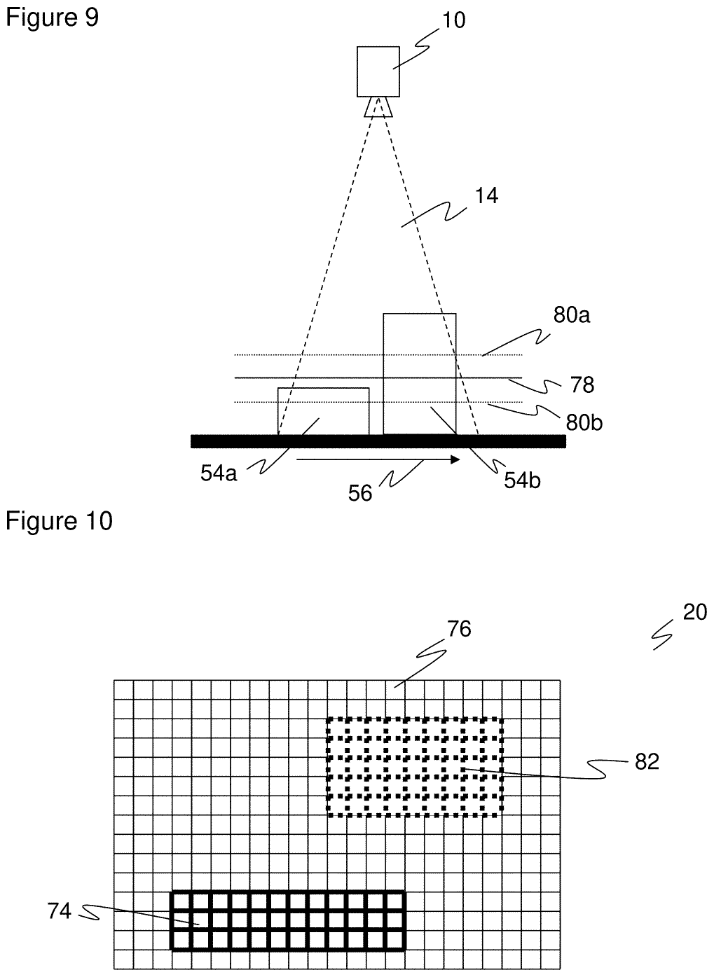

FIG. 9 a schematic sectional representation of the detection of two objects with a depth of field zone changed with respect to FIG. 7; and

FIG. 10 a schematic representation similar to FIG. 8, but now with a configured partial region corresponding to the region of interest disposed in the depth of field zone in FIG. 9.

FIG. 1 shows a schematic sectional representation of a camera 10. Received light 12 from a detection zone 14 is incident on a reception optics 16 with a focus adjustment 18 that conducts the received light 12 to an image sensor 20. The optical elements of the reception optics 16 are preferably configured as an objective composed of a plurality of lenses and other optical elements such as diaphragms, prisms, and the like, but here only represented by a lens for reasons of simplicity. The focus adjustment 18 is only shown purely schematically and can, for example, be implemented by a mechanical movement of elements of the reception optics 16 or of the image sensor 20, a moving deflection mirror, or a liquid lens. An actuator system is based, for example, on a motor, a moving coil, or a piezoelectric element. The image sensor 20 preferably has a matrix arrangement of pixel elements having a high resolution in the order of magnitude of megapixels, for example twelve megapixels. A configuration unit 22 enables a configuration of the reading logic of the image sensor 20 and thus a dynamically adjustable selection of pixel lines or pixel zones that are read from the image sensor 20.

To illuminate the detection zone 14 with transmitted light 24 during a recording of the camera 10, the camera 10 comprises an optional illumination unit 26 that is shown in FIG. 1 in the form of a simple light source and without a transmission optics. In other embodiments, a plurality of light sources such as LEDs or laser diodes are arranged around the reception path, in ring form, for example, and can also be multi-color and controllable in groups or individually to adapt parameters of the illumination unit 26 such as its color, intensity, and direction.

In addition to the actual image sensor 20 for detecting image data, the camera 10 has an optoelectronic distance sensor 28 that measures distances from objects in the detection zone 14 using a time of flight (TOF) process. The distance sensor 28 comprises a TOF light transmitter 30 having a TOF transmission optics 32 and a TOF light receiver 34 having a TOF reception optics 36. A TOF light signal 38 is thus transmitted and received again. A time of flight measurement unit 40 determines the time of flight of the TOF light signal 38 and determines from this the distance from an object at which the TOF light signal 38 was reflected back.

The TOF light receiver 34 preferably has a plurality of light reception elements 34a or pixels and is then spatially resolved. It is therefore not a single distance value that is detected, but rather a spatially resolved height profile (depth map, 3D image). Only a relatively small number of light reception elements 34a and thus a small lateral resolution of the height profile is preferably provided in this process. 2×2 pixels or even only 1×2 pixels can already be sufficient. A more highly laterally resolved height profile having n×m pixels, n, m>2, naturally allows more complex and more accurate evaluations. The number of pixels of the TOF light receiver 34, however, remains comparatively small with, for example, some tens, hundreds, or thousands of pixels or n, m≤10, n, m≤20, n, m≤50, or n, m≤100, far remote from typical megapixel resolutions of the image sensor 20.

The design and technology of the distance sensor 28 are purely by way of example. In the further description, the distance sensor 28 is treated as an encapsulated module for the geometry measurement that, for example, provides measured data such as a distance value or a height profile cyclically, on detecting an object, or on request. Further measured data are conceivable here, in particular a measurement of the intensity. The optoelectronic distance measurement by means of time of light processes is known and will therefore not be explained in detail. Two exemplary measurement processes are photomixing detection using a periodically modulated TOF light signal 38 and pulse time of flight measurement using a pulse modulated TOF light signal 38. There are also highly integrated solutions here in which the TOF light receiver 34 is accommodated on a common chip with the time of flight measurement unit 40 or at least parts thereof, for instance TDCs (time to digital converters) for time of flight measurements. In particular a TOF light receiver 34 is suitable for this purpose that is designed as a matrix of SPAD (single photon avalanche diode) light reception elements 34a. The TOF optics 32, 36 are shown only symbolically as respective individual lenses representative of any desired optics such as a microlens field.

A control and evaluation unit 42 is connected to the focus adjustment 18, to the image sensor 20, and to its configuration unit 26, to the illumination unit 22, and to the distance sensor 28 and is responsible for the control work, the evaluation work, and for other coordination work in the camera 10. It determines regions of interest using the measured data of the distance sensor 28 and configures the image sensor 20 via its configuration unit 22 corresponding to the regions of interest. It reads image data of the partial regions configured in this manner from the image sensor 20 and subjects them to further image processing steps. The control and evaluation unit 42 is preferably able to localize and decode code regions in the image data so that the camera 10 becomes a camera-based code reader.

The reading and first pre-processing steps such as equalization, segmentation, binarization, and the like preferably take place in a pre-processing unit 44 that, for example, comprises at least one FPGA (field programmable gate array). Alternatively, the preferably at least pre-processed image data are output via an interface 46 and the further image processing steps take place in a higher ranking control and evaluation unit, with practically any desired work distributions being conceivable. Further functions can be controlled using the measured data of the distance sensor 28, in particular a desired focus position for the focus adjustment 18 or a trigger time for the image recording can be derived.

The camera 10 is protected by a housing 48 that is terminated by a front screen 50 in the front region where the received light 12 is incident.

FIG. 2 shows a possible use of the camera 10 in an installation at a conveyor belt 52. The camera 10 is shown here and in the following only as a symbol and no longer with its structure already explained with reference to FIG. 1; only the distance sensor 28 is still shown as a functional block. The conveyor belt 52 conveys objects 54, as indicated by the arline 56, through the detection region 14 of the camera 10. The objects 54 can bear code zones 58 at their outer surfaces. It is the object of the camera 10 to detect properties of the objects 54 and, in a preferred use as a code reader, to recognize the code regions 58, to read and decode the codes affixed there, and to associate them with the respective associated object 54.

The field of view of the camera 10 preferably covers the stream of objects 54 in full width and over a certain length. Alternatively, additional cameras 10 are used whose fields of vision complement one another to reach the full width. A small overlap is preferably at most provided here. The perspective from above shown is particularly suitable in a number of cases. Alternatively or In order in particular also to better detect laterally applied code regions 60, additional cameras 10, not shown, are preferably used from different perspectives. Lateral perspectives, but also mixed perspectives obliquely from above or from the side are possible.

An encoder, not shown, can be provided at the conveyor belt 52 for determining the advance or the speed. Alternatively, the conveyor belt reliably moves with a known movement profile; corresponding information is transferred from a higher ranking control or the control and evaluation unit determines the speed itself by tracking certain geometrical structures or image features. Geometry information or image data recorded at different points in time and in different conveying positions can be assembled in the conveying direction and associated with each other using the speed information. An association between read code information and the object 54 bearing associated code 58, 60 in particular preferably thus also takes place.

FIG. 3 shows a three-dimensional view of an alternative embodiment of a device with the camera 10 at a conveyor belt 52. Instead of an internal distance sensor 28 or complementary thereto, an external geometry detection sensor 62, for example a laser scanner, arranged upstream against the conveying direction is provided here. As already explained, the measured data of the geometry detection sensor 62 can be converted to the position of the camera 10 on the basis of speed information. The now following description with reference to an internal distance sensor 28 can therefore be transferred to the situation with an external geometry detection sensor 62 without this having to be mentioned separately.

FIG. 4 shows a schematic sectional view of the camera 10 above an object stream that is only represented by a single object 54 here. The optical axis 64 of the distance sensor 28 is at an angle to the optical axis 66 of the camera 10. The field of view 68 of the distance sensor 28 is therefore arranged upstream of the field of view or of the detection zone 14 of the camera 10. The distance sensor 28 thus perceives the objects 54 a little earlier and its measured data are already available on the recording.

To reduce the image data to be processed from the start, the control and evaluation unit 42 divides its detection zone 14 and corresponding thereto regions of the image sensor 20 into relevant and non-relevant portions using the measured data of the distance sensor 28. A relevant portion here corresponds to a region of interest (ROI). Two differently shaded partial fields of view 70, 72 are shown in FIG. 4; a darker relevant partial field of view 70 with the object 54 and again a two-part brighter non-relevant partial field of view 72 without an object 54.

FIG. 5 shows the association division in a schematic plan view of the image sensor 20. The pixels in the boldly enclosed lines of the region of interest 74 correspond to the relevant partial field of view 70; the other pixels of regions 76 of no interest to the non-relevant partial field of view 72. The lines belonging to the region of interest 74 are selected by the control and evaluation unit 42 via the configuration unit 22 and only the image data of these pixels are read and further processed.

An exemplary evaluation by which the pixels of the region of interest 74 are located from the measured data of the distance sensor 28 will in turn be explained with reference to FIG. 4. The distance sensor 28 detects the object 54 having the height h at a first time at a time t. A trigger point t1 at which the object 54 will have moved into the detection zone 14 is determined using the relative location and pose of the distance sensor 28 with respect to the image sensor and the conveying speed. The length of the object 54 is determined from the measured data of the distance sensor 28 up to the time t1. The distance sensor 28 is, for example, operated at a repetition rate f. The length of the object 54 corresponds to the number of detections at this repetition rate. It must be remembered that positions and lengths in the conveying direction can be directly converted into lines via the conveying speed. With knowledge of the respective positions and poses of the camera 10 and the distance sensor 28 or the external geometry sensor 62, the object length determined by means of the distance sensor 28 can thus be trigonometrically converted into associated image lines on the image sensor 20 while taking the object height into consideration.

In the course of the conveying movement, the relevant partial region 70 is displaced in accordance with FIG. 4 against the conveying direction or the region of the interest 74 downwardly on the image sensor 20 in FIG. 5. A first image resolution can be coordinated in time such that the front edge of the object 54 lies at the margin of the detection zone 14 and thus in the uppermost line of the image sensor 20. The image sensor 20 can be repeatedly dynamically reconfigured to record the object 54 or any other structure of interest such as a code region 58, 60 on the object multiple times.

FIG. 6 shows an alternative division of the pixels of the image sensor 20 in regions to be read and not to be read. Unlike FIG. 5, the condition that the region of interest 74 may only comprise whole lines is dispensed with here. The image data to be read and processed is thereby reduced still further. The configuration unit 22 is accordingly more flexible and also allows the exclusion of pixels within the lines. This preferably still means no individual pixel selection that would lead to too high a switching effort, but the selection possibility of rectangular partial regions as shown. To be able to make a sensible selection of pixels within the line and thus transversely to the stream of objects 54, the distance sensor 28 should preferably provide a lateral resolution so that a contour of the objects 54 resolved in the conveying direction and transversely thereto is successively available.

FIG. 7 shows a situation in a schematic sectional representation in which there are two objects 54a-b of different heights in the detection zone 14. A depth of field zone enclosed by an upper and lower DOF (depth of field) boundary 80a-b can be displaced by setting the focal position 78 by means of the focus adjustment 18. The depth of field zone in the respective focal position 78 depends on different factors, in particular on the reception optics 16, but also, for example, on the decoding method, since whether the code is readable is decisive for a sufficient image focus on the code reading. The control and evaluation unit 42 can, for example, access a look-up table with depth of field zones determined in advance by simulation, modeling, or empirically.

Due to the measured data of the distance sensor 28 and the information on the depth of field zone at a focal position 78, the control and evaluation unit 42 is thus aware of how the focal position 78 has to be changed to record one of the objects 54a-b in focus. As long as there is a focal position 78 with a depth of field zone suitable for all the objects 54a-b, the number of lines to be read can be increased for two or more objects 54 by means of the configuration unit 22 or a further region of interest 74 to be read can be provided on the image sensor 20. A single recording is then possibly sufficient for a plurality of objects 54a-b, with a repeat recording remaining possible just like separate recordings for every object 54a-b.

In the situation of FIG. 7, however, the height of the objects 54a-v is too different; there is no focal position 78 at which the two objects 54a-b would lie within the depth of field zone. The control and evaluation unit 42 has to make a decision and initially focuses on the higher object 54b.

FIG. 8 shows a schematic plan view of the image sensor 20 set for this situation by means of the configuration unit 22. Only the region of interest 74 corresponding to the higher object 54b recorded in focus is read. Alternatively to a rectangular partial zone, the total image lines expanded to the right and to the left could be configured and read. There is per se a further region of interest 82 corresponding to the lower object 54a and the control and evaluation unit 42 is aware of this by evaluating the measured data of the distance sensor 28. Since, however, no sufficiently focused image data are anyway to be expected in the further region of interest 82, they are treated as regions of no interest 76 and are not read. With a smaller height difference at which the lower object 54a is still in the depth of field zone, two regions of interest 74, 82 could be configured and read provided that the configuration unit 22 provides this function or both regions of interest 74, 82 are surrounded by a common region of interest.

FIGS. 9 and 10 show a situation complementary to FIGS. 7 and 8. The focal position 78 and the associated depth of field zone are now set to the lower object 54a. Its image data are correspondingly read and those of the higher object 54b are discarded together with the regions between and next to the objects 54a-b directly in the image sensor 20.

It is thus possible to generate a first recording with a focal position 78 for the higher object 54b and directly thereafter, at least as long as the lower object 54a is still in the detection zone 14, a second recording after a refocusing and thus adaptation of the focal position 78 to the lower objects 54a. The control and evaluation unit 42 is even informed in good time of the described conflict situation due to the measured data of the distance sensor 28 and can plan in advance.

In an alternative embodiment, the focal position 78 is cyclically changed, for example by a step function or by an oscillation. A plurality of recordings are generated so that the depth of field zones overall cover the total possible distance zone, preferably excluding the conveying plane itself, provided that very flat objects 54 are also not to be expected. Respective regions of interest 74 that are recorded in focus in the current focal position 78 are configured using the measured data of the distance sensor 28. The respective focal position 78 thus determines the regions of interest 74. It is ensured that every structure is recorded in focus and blurry image data are not read at all.

In accordance with the invention, the advantages of a large image sensor 20 are thus implemented without thus triggering a flood of data that can no longer be managed. At the same time, the problem of blurry image data of a plurality of sequential objects 54a-b of greatly different heights in a single large recording is solved. It thus becomes possible to cover the stream of objects t4 solely by an image sensor 20, at least with respect to its perspective, for instance, from above or from the side, or at least to cover a portion that is as large as possible.

Conventionally, in contrast, the pre-processing unit would have to read all the image data only then, where necessary, to discard image data outside of regions of interest. The pre-processing conventionally already takes place on the fly in a pipeline structure during the reading so that the reading and pre-processing are practically not to be considered differently in the time demands. For an image sensor 20 of high resolution this requires a processing time of 25 ms, for example, and thus limits the recording frequency or frame rate to 40 Hz. The situation becomes worse due to more complex image processing steps; the possible recording frequency drops further. If two objects of very different heights now closely follow one another, a second recording after refocusing may possibly be too late. In accordance with the invention, in contrast, the image data quantity is reduced from the start to only read relevant image data. The reduced data load is already an advantage in itself since resources are thus saved or can be used in a more targeted manner. The camera 10 thus selectively becomes less expensive or more powerful. in addition, the strict limitation of the recording frequency corresponding to a processing time for the complete images is dispensed with. The recording frequency can therefore be flexibly increased in total or even from case to case. A second recording in good time after refocusing thus also becomes possible in the situation of two objects 54a-b of greatly different heights following closely on one another, as explained with respect to FIGS. 7-10.

1. A camera device for detecting a stream of objects moved relative to the camera device, wherein the camera device has an image sensor for recording image data of the objects, a geometry detection sensor for measuring the objects, and a control and evaluation unit that is configured to determine at least one region of interest using measured data of the geometry detection sensor to restrict the evaluation of the image data to the region of interest,
wherein the image sensor has a configuration unit to enable the reading of only a settable portion of the respectively recorded image data; and
with the control and evaluation unit being configured only to read a portion of the image data from the image sensor that is determined with reference to the region of interest.

2. The camera device in accordance with claim 1,
wherein the control and evaluation unit is configured to adapt at least one of the at least one region of interest and the read portion of the image data between the recordings.

3. The camera device in accordance with claim 1,
wherein the control and evaluation has a pre-processing unit to read and pre-process image data from the image sensor, with the pre-processing unit being configured such that the reading and pre-processing of the complete image data of a recording of the image sensor require a complete pre-processing time and with the image sensor being operated at a recording frequency that leaves less time between two recordings than the complete pre-processing time.

4. The camera device in accordance with claim 1,
wherein the recording frequency is a flexible recording frequency.

5. The camera device in accordance with claim 1,
wherein the user interface is configured for a selection of image lines.

6. The camera device in accordance with claim 1,
wherein the configuration unit is configured for the selection of a rectangular partial region.

7. The camera device in accordance with claim 1,
wherein the control and evaluation unit is configured only to read that portion of image data from the image sensor that has been recorded with reference to a region of interest within a depth of field zone of the image sensor.

8. The camera device in accordance with claim 1,
wherein the control and evaluation unit is configured to determine a suitable depth of field zone for a region of interest outside the depth of field zone and to refocus to the suitable depth of field zone for a following recording.

9. The camera device in accordance with claim 1,
wherein the control and evaluation unit is configured to determine the at least one region of interest with reference to a depth of field zone of the image sensor.

10. The camera apparatus in accordance with claim 1,
wherein the control and evaluation unit is configured to identify code regions in the image data and to read their code content.

11. The camera device in accordance with claim 1,
wherein the geometry detection sensor is configured as a distance sensor.

12. The camera device in accordance with claim 11,
wherein the distance sensor is an optoelectronic distance sensor in accordance with the principle of the time of flight method.

13. The camera device in accordance with claim 1,
wherein the geometry detection sensor is arranged integrated with the image sensor in a camera or externally and disposed upstream of the image sensor against the flow to measure the objects before the recording of the image data.

14. The camera device in accordance with claim 1,
that has a speed sensor for a determination of the seed of the stream.

15. The camera device in accordance with claim 1,
wherein the control and evaluation unit is configured to determine the speed of the stream with reference to the measured data of the geometry detection sensor and/or the image data.

16. The camera device in accordance with claim 1,
that is installed stationary at a conveying device that conveys the objects in a conveying direction.

17. The camera device in accordance with claim 1
that has at least one image sensor for a recording of the stream from above.

18. The camera device in accordance with claim 1
that has at least one image sensor for a recording of the stream from the side.

19. A method of detecting a moving stream of objects, wherein image data of the objects are recorded by an image sensor, the objects are measured by a geometry detection sensor, and at least one region of interest is determined with reference to measured data of the geometry detection sensor to restrict the evaluation of the image data to the region of interest,
wherein the image sensor is configured to only read a portion of the image data from the image sensor determined with reference to the region of interest.
